(19) United States
(12) Patent Application Publication
(10) Pub. No.: US 2010/0320773 A1
(43) Pub. Date: Dec. 23, 2010

(54) SPACECRAFT ELECTRIC REGENERATOR

(76) Inventor: Jayantha Liyanage, Kurunegala (LK)

Correspondence Address: Jayantha Liyanage, 14/7 Dharmapala Avenue, Pollatthapitiya, Kurunegala, LK

(21) Appl. No.: 12/311,797

(22) PCT Filed: Sep. 20, 2007
(86) PCT No.: PCT/IB2007/002723

§ 371 Date: Apr. 14, 2009

(30) Foreign Application Priority Data
Sep. 21, 2006 (LK) 14223

(51) Int. Cl. H02K 7/18; H02K 53/00

(52) U.S. Cl. 290/1 A; 415/916

(57) ABSTRACT

Spacecraft electric regenerator, a power regenerative device that generates electrical power to spacecrafts. The device generates its own power by rotating a rotor disc with magnetic Pole pieces attached to its inner bore around an armature coil assembly fixed to a stationary shaft. The rotor disc being rotated to a predetermined velocity by a starter mechanism and the rotation thereafter being maintained under a zero gravity and in vacuum conditions due to the accumulated kinetic energy. To overcome any inherent and imposed retarding forces, the rotation being assisted by transferring the rotational power of an electric driver motor as magnetic power from a driver disc with magnetic Pole pieces attached to its outer circumference surface. The rotation being controlled and maintained by a power control and conversion process in order to sustain the power regenerative cycle.

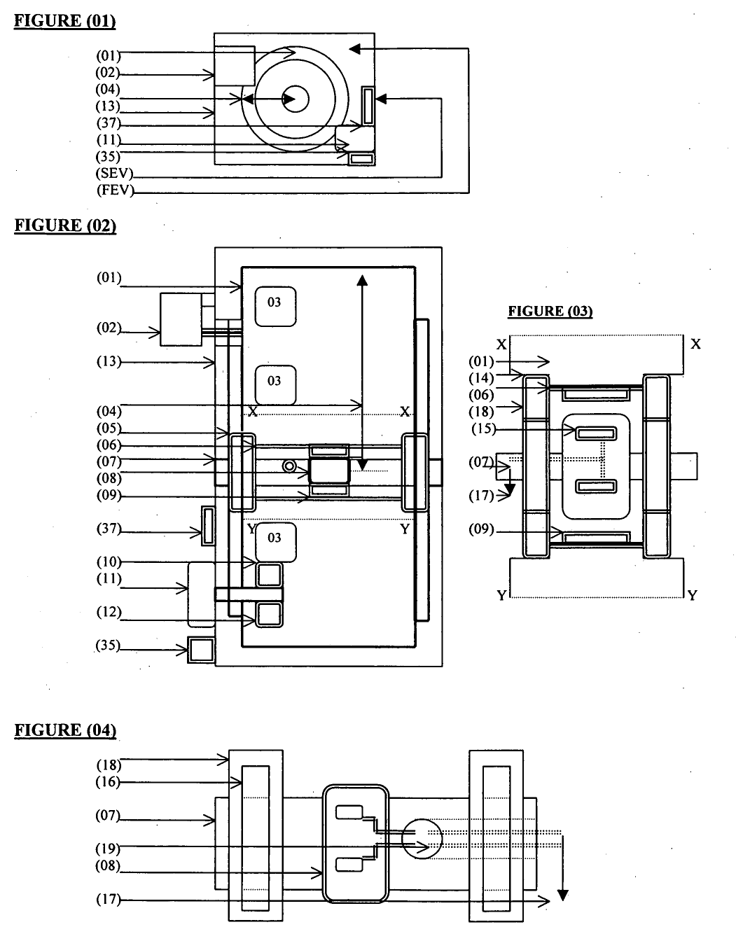

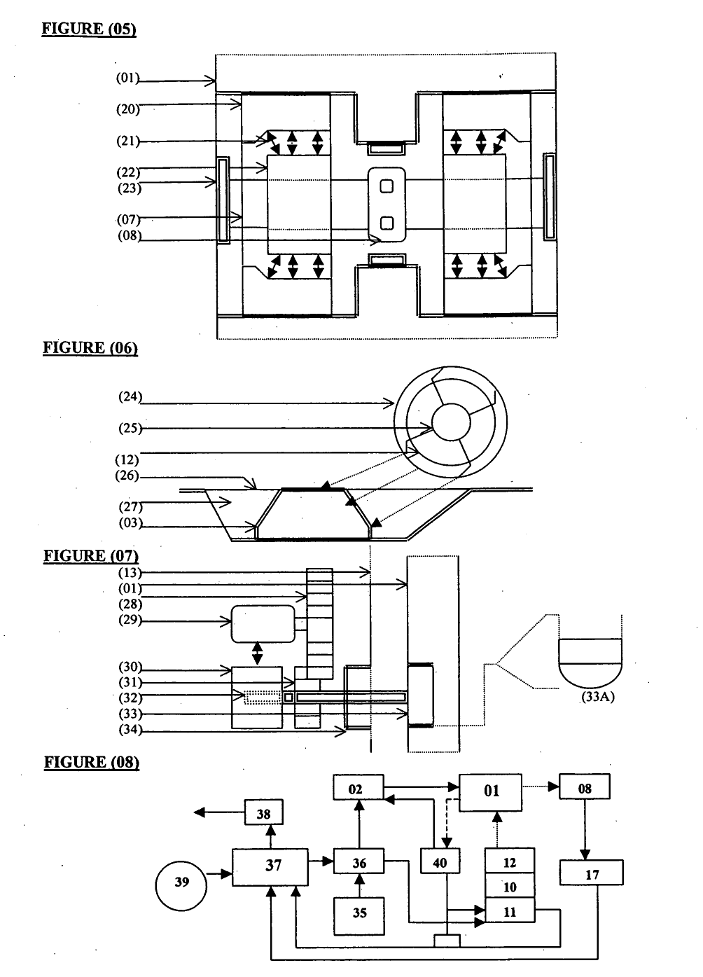

### FIELD OF THE INVENTION

The invention belongs to the field of electrical power generation in the outer space.

### REFERENCE TO AN EARLIER APPLICATION

This application is based on the Sri Lanka national patent application No: 14223, dated 21 Sep. 2006, titled as space electric regenerator, in which the first priority date being claimed.

### BACKGROUND OF THE INVENTION

### The Prior Art

Spacecrafts like the space shuttle is likely to use batteries charged by conventional generators for short-term use. Earth orbiting satellites and the International Space Station uses solar power converted to electrical power through solar cells for medium to long-term use. Nuclear materials are being used for long-term power generation for spacecrafts such as the Voyager spacecraft with the limitation of continuous use to a few decades.

The power regeneration said to be one of the most difficult areas to achieve its intended target. It is in this background that this inventor thought that major obstacles posed for power regenerative devices could be eliminated by changing the environment of operation. The conditions that exist on earth seem to be the key factors that prevent various power regenerative designs from working especially making a significant use of the lever effect. The downward gravitational force, the bearing friction that occurs due to it and the atmospheric air friction are the main forces that affect all power regenerative devices.

The design in this disclosure adopts various first principles and methods into a new inventive design based on a new environmental condition consisting both natural and artificial conditions are being used to overcome the major difficulties that the power regeneration faces. The disclosure contains extensive modification of various parts that are generally designed according to an accepted norm based on certain requirements.

### SUMMARY OF THE INVENTION

Spacecraft Electric Regenerator, a power regenerative device that operates under zero gravity condition that exists in the outer space and in a vacuum condition created artificially thereby making use of these two conditions to achieve a retarding free rotation. A two diameter rotor disc consists of a relatively large mass with a substantially large outer diameter relative to its two diameter common center bore consists of three circular disc sections enclosed inside a vacuum chamber. To the inner circumference surface of the smaller diameter bore of the said rotor disc, an even number, usually consists of two or four magnetic Pole pieces being attached. The rotor disc being rotated with the outer rings of two bearings inserted to the two ends that comprises the larger diameter bores. The rotor disc has been rotated around an armature coil assembly. The armature coil assembly consists of an even number of Poles wound with coils to generate an alternating voltage-current that has been routed through a bore made in a stationary shaft. The armature coil assembly consists of a bore made in the lamination that has been fixed to the center of the said stationary shaft, which in turn has been inserted from its two ends to the two inner rings of the said bearings from, inside. The rotor disc being rotated to a predetermined velocity from a starter mechanism using power from a precharged storage device such as a battery or from a capacitor bank. The predetermined velocity being maintained under the said conditions assisted by a magnetic force imparted continuously to the outer circumference surface of the rotor disc with magnetic Pole pieces attached by a driver disc with magnetic Pole pieces attached to its outer circumference surface with equal spacing. A power control and conversion process being used to control the rotational process. The rotor disc, the stationary shaft, the armature coil assembly, the driver disc has been enclosed inside the said vacuum chamber. The bulk of the starter mechanism, the geared electric motor, the power control module and the storage device have been fixed to the outer casing of a vacuum chamber.

The advantages include the devices ability to generate power by a power regenerative method making use of the ideal outer space environmental conditions for long-term use continuously.

### THE DESCRIPTION

### The Purpose of the Invention

In the outer space environment, mass is not so much of a problem for spacecrafts as it would continue to travel to its target once it gains its momentum. But generating electrical power for internal use is a serious problem for spacecrafts; even a small amount is of vital importance even having to increase the total mass of the spacecraft Therefore, if a device could cater for such a need, then that would be a significant advancement for space travel. The purpose of this invention is to design an electric power regenerator for long distance spacecrafts without using an external power source by using a power regenerative process.

### The Principles of Operation

Spacecraft electric regenerator (SERG) is a power regenerative device designed to operate in a zero gravity environmental condition within an artificial vacuum condition created in which the power generating and converting components of the device being enclosed, thereby making use of the ideal environmental conditions that exists and created combining with other phenomenon to generate power.

There are three main retarding forces that prevent a wheel from rotating for a very long period under earth conditions. They are the downward gravitational force, the bearing friction caused due to the gravitational force and the air friction. In addition to this, molecular attraction of bearing parts is also a retarding force that needs to be addressed through technological means. The outer space environment eliminates the main retarding force, the gravitational force almost completely. The bearing friction that occurs due to the said gravity would be reduced to an insignificant level in the absence of gravity. The problem of air friction has been solved greatly by enclosing the moving parts within a vacuum chamber.

It is known that a rotating circular disc would accumulate a certain amount of kinetic energy depending on its mass and speed in relation to other parameters such as the diameter, the circumferential width and the type of material used. Therefore, it is possible and particularly easy if the retarding forces that occur within the earth conditions, the frame of reference that we assume things could be kept to an insignificant level, then a circular disc consists of relatively large mass would rotate for a very long period of time overcoming any retaining retarding forces or any insignificant external influences as well as an imposed retarding force.

This imposed retarding force is a prime requirement for power generation almost in all known environmental conditions. It is also possible to make this enforce retarding force also somewhat insignificant relative to the kinetic energy that could be made to gain by rotating a circular disc of large mass. Therefore, there are certain design considerations that have to be taken into account in order to find the optimum specifications to generate a certain amount of additional power for the external use.

(01). A rotor disc consists of a relatively large mass that rotates at a relatively high speed, hence to generating relatively large amounts of kinetic energy.
(02). An armature coil assembly that generates a relatively small amounts of power, which means relative to the above said kinetic energy.
(03). An assisted force that makes full use of the lever effect with other design consideration that consumes relatively low amounts of power.
(04). The outer surface design of the rotor disc and driver disc that offer minimum friction to any remaining molecules in the vacuum chamber.
(05). Making use of the best technology to construct all the components to make them highly efficient thereby reducing the waste energy.

### THE DETAILS OF THE DRAWINGS

Figures show the main components of the preferred embodiment. Figures are not drawn to a scale, but drawn only to highlight the main features. The arrow ( [symbol] ) represents an item, the arrow ( [symbol] ) represents magnetic field forces, the arrow ( [symbol] )represents a direction, power, signal or a length. The description herein makes references to the drawings numbered as FIG. (01)-to-FIG. (08), wherein like reference numbers refer to same parts throughout the figures, wherein;

FIG. (01) is a frontal view showing the main components of the device where the rotor disc rotates vertically and the stationary shaft fixed parallel to the ground surface with the side elevation view marked as “SEV”.

FIG. (02) is a fragmentary, side elevation view (SEV) of the preferred embodiment constructed accordingly with inner bore area opened [X-X & Y-Y] for clearer view and depicting all the main components of the device as connected to the vacuum chamber, wherein certain parts are being fitted to the outer casing. In this view, the bearings fitted being the ball type bearing.

FIG. (03) is a fragmentary, side elevation view (SEV) of the inner bore area of the rotor disc opened to show the armature coil assembly inserted to a stationary shaft that has been inserted to two ball type bearings with two magnetic Pole pieces attached. The voltage-current line being taken out from one end of the shaft wherein only part of the center diameter of the rotor disc is shown.

FIG. (04) is a fragmentary, side elevation view (SEV) showing how voltage-current line from the armature coil assembly being routed through a bore drilled in the surface of the stationary shaft and along a bore made in the center of the shaft and out from one end.

FIG. (05) is a fragmentary, side elevation view (SEV) of the two magnetic bearings with two outer magnetic rings dissected from the middle in order to show the two inner rings.

FIG. (06) is a part of the fragmented front elevation view (FEV) showing the driver disc with two magnetic Pole pieces attached imparts its field forces onto a magnetic Pole piece attached to the outer circumferential surface of the center area of the rotor disc with the Pole piece imbedded inside a trapezium like opening covered by a thin non magnetic metal plate.

FIG. (07) is a fragmentary, side elevation view (SEV) showing how the rotor Tip of the starter mechanism connected to the outer circumference surface of one of the smaller diameter discs of the rotor disc with a section inside the vacuum chamber casing to which the rotor Tip of the starter mechanism is drawn after rotating the rotor disc to a predetermined velocity.

FIG. (08) shows the power control process as a sequential block diagram.

### THE PREFERRED EMBODIMENT

The preferred embodiment of the spacecraft electric regenerator consists of a rotor disc with a center bore comprising permanent magnetic Pole pieces, the rotor disc rotates with the outer rings of two bearings inserted to a stationary shaft that has been fixed to the inner casing of a vacuum chamber. An armature coil assembly has been inserted to the stationary shaft around which the Pole pieces rotate. The vacuum chamber encloses a drive motor with its driver disc, the rotor tip of the starter mechanism. Main parts of the starter mechanism, the storage device and the power control module with an externally controlled ON-OFF switch that has been fixed to the outer casing of the vacuum chamber.

The following list contains all the components of the device. Rotor disc (01), Starter mechanism (02), Magnetic Pole pieces attached to the outer circumference surface of the rotor disc (03), Outer diameter of the rotor disc (04), Large diameter section of the center bore (05), Small diameter section of the center bore (06), Stationary shaft (07), Armature coil assembly (08), Magnetic Pole pieces attached to the center bore of the rotor disc (09), Driver disc (10), Geared electric high speed driver motor (11), Magnetic Pole pieces attached to the driver disc (12), Vacuum chamber casing (13), Bearing outer ring (14), Armature coil (15), Bearing inner ring (16), Voltage-Current line (17), Ball bearing (18), Stationary shaft surface bore (19), Magnetic bearing outer ring (dissected vertically) (20), Magnetic field forces (21), Magnetic bearing inner ring (22), Non magnetic fixture (23), Spacing length between magnetic Pole pieces attached to the driver disc (24), Driver motor shaft (25), Non magnetic metal plate (26), Trapezium like opening (27), First gear wheel of the starter mechanism (28), High speed-high torque electric motor (29), Starter mechanism control box (30), Second gear wheel of the starter mechanism (31), Starter mechanism shaft (32), Starter mechanism rotor Tip (33), Rubber lining attached to the rotor Tip (33A), Vacuum chamber casing opening to insert the rotor Tip of the starter mechanism (34), Storage device (35), ON-OFF Switch (36), Power control module (37), Power outlet (38), External signal (39), RPM measuring circuit(40), Side elevation view (SEV), Front elevation view (FEV).

### THE MAIN COMPONENTS OF THE PREFERRED EMBODIMENT

With Reference to FIGS. (01) & (02)

The rotor disc (01) comprises a two diameter circular disc made froth a high-density metal or metal alloy from one of the highest available with the ability to withstand high rotational speeds and with a low material evaporation rate inside a high vacuum condition. The outer diameter of the rotor disc (04) is substantially larger than the larger diameter section of the center bore (05), herein substantially means several folds of the said bore diameters. To the outer faces of the center disc, two smaller diameter discs of equal diameters being made or machined where smaller means slightly smaller than the outer diameter of the rotor disc (04). These two discs have been made smaller because such a configuration gives a better rotational stability than a singular diameter disc and also for the starter mechanism (02) to rotate the rotor disc (01) to a predetermined velocity using one of the smaller diameter disc's outer circumference surfaces. The other smaller diameter disc acts as a counter-balancing disc to maintain the rotational stability. The surfaces and edges of the rotor disc being finely polished to an extent that a similar surface adheres to it due to molecular attraction. This feature is to reduce the air friction. The vacuum chamber consists of a low-high vacuum with remaining gas molecules mostly consists of Helium.

The said center bore consists of a two diameter bore with a smaller bore (06) made in the center area comprising most of the center disc width of the rotor disc (01) with two larger diameter bores (05) made from the two ends of the center bore to which two ball type bearings (18) or magnetic bearings [(20)-(22)] inserted. The rotor disc (01) rotates with the outer rings of the said bearings while the inner rings remain stationary. This feature is of particular importance as it has been noticed that such rotation is highly efficient with less bearing friction.

With Reference to FIGS. (03) & (04)

A metal shaft (07) being inserted from its two ends to the inner rings (16) of the said bearings from inside protruding out of the bearings and fixed into the inner side of the vacuum chamber casing (13) with a bush like fixture for ball or roller type bearings specially designed for high vacuum conditions or with a non magnetic fixture (22) when magnetic bearings [(20)-(22)] is used. An armature coil assembly (08) comprising Poles (15) cut from laminations wound with silver or gold alloy wire. The lamination consist a bore with a substantially large diameter when compared with other armature coil assemblies that exists in motors and generators that has been inserted to the shaft (07) and positioned in the center of the shaft. A surface bore (19) drilled near the armature coil assembly (08) from one-side merges with a bore drilled in the center of the shaft (07) diameter. The voltage-current generated in the armature coil assembly (08) being routed into the surface bore (19) along the said center bore of the shaft (07) and out from one end of the shaft (07) as a voltage-current line out (17) and has been connected to the power control module (37) that has been connected a storage device (35). Routing the voltage-current line through the bearings is a new feature as there is simply no other way to do it except along a groove made in the surface of the shaft, a method, which is not very satisfactory.

Two magnetic Pole pieces made of magnetic materials that are especially suitable for vacuum conditions has been fixed along the inner circumference surface of the smaller diameter bore (06) of the rotor disc (01) with equal spacing between the Pole pieces. The strength of the inner magnetic Pole pieces (09) attached being much higher than three (03) MGOs.

The rotor disc (01) being rotated to a predetermined velocity by the starter mechanism (02) where the predetermined velocity is the highest that could be attained in relation to the number of magnetic Pole pieces attached to the smaller diameter bore (06) and to the number of armature Poles made in the armature coil assembly (08). The said numbers being the minimum number used for the highest velocity. The number of armature Poles (15) being twice the number of magnetic Pole pieces attached (09).

With Reference to FIG. (05)

The magnetic bearing provides a method in which no interaction between bearings parts occur as happens in ball bearings. The magnetic bearing consists of two rings in which one being an outer magnetic ring (20) and the other inner magnetic ring (22), in which the inner circumference surface of the center bore of the outer ring and the outer circumference surface of the inner ring being of same type of Pole. The strength of the two magnetic rings being so chosen, when the rotor disc (01) and the stationary shaft (07) are fitted, there creates a magnetically balanced region in which smooth rotation takes place.

With Reference to FIG. (06)

The specification of the rotor disc (01) being so determined that the kinetic energy generated at a predetermined velocity exceeds considerably than the total energy consumed by the retarding forces that acts against the rotation. To cater for such situation that is, if retardation occurs despite making the retarding forces insignificant in relation to the kinetic energy generated by the rotor disc (01) at a predetermined velocity, an assisted force being imparted continuously in the form of magnetic power to the outer circumference surface of the rotor disc (01). Permanent magnetic Pole pieces (03) attached with equal spacing between the Pole pieces to the outer circumference area of the rotor disc (01), to which a rotational magnetic force being imparted continuously from a driver disc (10) with two magnetic Pole pieces (12) attached to its outer circumference surface with equal spacing (24) between the Pole pieces. The driver disc being rotated by a high-speed electric driver motor incorporating a geared speed increase mechanism (11). This way the rotational power of the electric driver motor being transferred to the magnetic Pole pieces (03) attached to the outer circumference surface of the rotor disc (01) as magnetic power. The initial power to the electric driver motor (11) being derived from the storage device (35) through the power control module (37). It is also possible to rotate the rotor disc (01) to a predetermined velocity by this assisted force along.

With Reference to FIG. (07)

The starter mechanism (02) consists of a high-speed-high torque electric motor (29) with its drive shaft connected directly to the first gear wheel (28). The second gear wheel (31) being a smaller wheel relative to the first gear wheel (28) that meshes with the first gear wheel (28). An electromechanical control box (30) controls the drive shaft (32) that consists of rotor Tip in the form of a circular disc at the end with a circular rubber lining that covers the outer circumference surface, which is capable of rotating the rotor disc (01) to a predetermined velocity by rotational drag with a friction level just sufficient for the said drag without enforcing any undue friction that would consume unnecessary power from the storage device (35). The rotor Tip of the starter mechanism (33) initially being positioned so that the circumference surface of the rubber lining (33A) of the said rotor Tip (33) and the outer circumference surface of one of the smaller circular discs of the rotor disc (01) overlaps and touches the said outer circumference surface.

With Reference to FIG. (08)

To start the rotational process of the SERG, after setting the said initial mechanical position of the rotor Tip (33) of the starter mechanism (02), an ON-OFF switch (36), kept under OFF position turned to ON position through the power control module (37) from an external signal (39). The starter mechanism (02) then draws power from the storage device (35). The starter motor (29) that made to rotate at a slowly increasing velocity until the rotor disc (01) reaches the predetermined velocity. An R.P.M measuring circuit (40) disconnects power to the starter motor (29) when the said velocity is reached and the starter mechanism drive shaft (32) is pulled back to a position carved out (34) in the inner side of the vacuum chamber casing. In addition to turning power ON to the starter mechanism (02), power is turned ON to the geared electric driver motor (11) to rotate the driver disc (10) to a predetermined velocity gradually, where its velocity matches the said predetermined velocity of the rotor disc required to synchronize the rotor disc and the driver disc nearly, the speed thereafter being controlled by reducing or by increasing its speed so as to synchronize the driver disc (10) with rotor disc (01). The starter mechanism, and the driver motor consist of its own control circuits. To achieve rotational stability, a time delay is initiated in the power control module (37) from the signals received from the RPM measuring circuit (40) and from the geared electric driver motor (11). Once the system assumes a stable rotation, then the power is drawn from the voltage-current line (17) at a rate, which is so small that no significant retarding force would enforce the rotation of the rotor disc (01). This way the rotor disc (01) is made to adjust itself with the said assisted magnetic power from the driver disc (10), which in turn controls itself by drawing more current from the storage device (35) in relation to the retarding forces experiences by the rotor disc (01). The voltage-current generated by the armature coil assembly (08) is used to recharge the storage device (35) through an alternating current to direct current converting unit incorporated to the power control module (37). Once this is achieved, then the device achieves its intend power regeneration. Thereafter, power could be drawn from the storage device for the external use. The amount of current drawn is carefully controlled so no extra amount of current would be drawn from the storage device (35) under any circumstances. These criterions are vital for proper operation of the SERG

### THE DISCLOSURE FOR AN EARTH BOUND DESIGN

The priority document for this application does not contain the disclosure contains in this page The inventor has decided to disclose the following details as testing a model for the spacecraft electric regenerator is beyond the inventors reach, a frustrating situation. Therefore. the possibility of adopting the design disclosed for the earth condition has being considered and has come up with the following conclusions.

The invention disclosed primarily designed to operate under a zero gravity condition thereby taking the advantage of not having a downward force. It is not possible, at present or in the foreseeable future to create an artificial zero gravity condition under the earth condition. Even such advancement occurs, it would consume large amounts of power to maintain such a condition outweighing any advantage acquired by the design unless an anti gravity could be achieved from a condition similar to that occurs in permanent magnetic Pole pieces something which is extremity unlikely.

The spacecraft electric regenerator disclosed could be mounted vertically or horizontally to the ground surface of the spacecraft without any effect to its rotation as there is no up or down in the outer space. But that condition is different for the earth condition as there is a direction called downward.

There is no alternative solution to the downward gravitational force but to work against it by other means. It is also possible that the device would work as it is if the optimum specification could be found and in the vertically rotating position and without the vacuum condition. Alternatively the design disclosed might have to be adopted with certain improved or new design considerations.

It has being observed that a wheel that rotates vertically tends to stop faster than a wheel that rotates horizontally, that means the two outer faces rotates parallel to the ground surface. This way the bearing friction being reduced to some extent. In this earth bound design, the rotor disc rotates horizontally. Taking such factors into consideration, the following design improvements could be done to achieve that and a prototype working model could be built and test incorporating such improvements while keeping the main design consideration largely unaffected.

(01). The device mounted on a horizolital plan where the rotor disc rotates horizontally and that means the two outer faces rotates parallel to the ground surface.
(02). The vacuum chamber consists of a low vacuum condition thereby making internal design consideration easier while making the internal parts free from dust and dirt.
(03). The vacuum chamber casing being improved by incorporating a rectangular shape metal structure around the outer casing to withstand high rotational speed together with the weight of the design.
(04). The bearing fixed to the bottom smaller circular disc could be a tapered roller bearing type with some sonic structural improvements around it to take up the weight of the rotor disc.
(05). The rotor disc could be rotated to an extremely high speed incorporating a speed reduction mechanism to the center bore area of the rotor disc that consist of the voltage-current generating part.
(06). The use of an alternating current motor with a fixed speed by rotating the rotor disc to a slightly higher speed than its predetermined speed that matches with a predetermined speed of the A.C electric motor.
(07). Detailed electronic control circuits that controls the entire rotational process and the power conversion process.

The applicant Claims a new priority date as the date of receipt by the PCT Receiving Office Section for the disclosure in this page thereby facilitating the applicant to make a new or a divisional PCT application within the allowed period based on the outer space design but incorporating new improvements in which a new set of Claims could be made possibly with the specification of an economically viable working model with power specifications.

1. Spacecraft electric regenerator, a power regenerative device that operates under zero gravity and in vacuum conditions comprises a two diameter rotor disc with a substantially large outer diameter relative to the larger diameter of its two diameter center bore, to the inner circumference surface of the smaller diameter bore, an even number of magnetic Pole pieces attached, the rotor disc rotates with the outer rings of two bearings inserted to the two ends that comprises the larger diameter bores and around an armature coil assembly fixed to the center of a stationary shaft which in turn been inserted from its two ends to the two inner rings of the said bearings from inside, the rotor disc being rotated to a predetermined velocity from a starter mechanism using the power derived from a precharged storage device, the velocity being maintained under the said conditions assisted by a magnetic force imparted from an electric motor-driver disc continuously to the rotor disc using a power control-conversion process, the rotor disc, the shaft, the coil assembly, an electric motor-driver disc, the rotor Tip been enclosed in a vacuum chamber while the rest of the starter mechanism, the power control module storage device fixed to the outer casing of the said vacuum chamber.

2. Spacecraft electric regenerator according to claim (01), in which the said even number of magnetic Pole pieces attached to the said inner circumference surface of the said smaller diameter bore being the minimum even number of permanent magnetic Pole pieces with equal spacing that rotates around the said armature coil assembly, which comprises Poles cut from lamination, the number of said Poles cut being twice the said even number for the highest speed to generate a voltage-current.

3. Spacecraft electric regenerator according to claim (01), in which the voltage-current line generated in the said armature coil assembly being routed into a surface bore made in the said stationary shaft and along a center bore made parallel to the shaft's outer surface from one side and taken out from that end and been connected to the said power control module.

4. Spacecraft electric regenerator according to claim (01), in which the said bearing being magnetic type bearing consists of a larger magnetic ring with a center bore to which a smaller magnetic ring with a center bore being inserted with the inner circumference surface of the larger ring and the outer circumference surface of the smaller ring surfaces comprises of same type of magnetic Pole with the two surfaces overlap each other and been positioned in which the magnetic field forces emanating from the two circumference surfaces balances out each other, the said larger magnetic ring inserted to the larger diameter center bore of the said rotor disc, the said shaft being inserted to the center bore of the smaller magnetic ring.

5. Spacecraft electric regenerator according to claim (01), in which the said starter mechanism comprises a high speed-high torque electric motor with a speed increase mechanism in which a first larger gear wheel inserted to the drive shaft of the said motor meshes with a second smaller gear wheel to which a shaft inserted to its center bore that consists of a rotor Tip at one end with a rubber lining fixed, in which the said shaft moves to and fro but locks with the second gear wheel upon rotation, the shaft is pulled back and being locked when the said predetermined velocity of the rotor disc is reached.

6. Spacecraft electric regenerator according to claim 01), in which the said assisted magnetic force being imparted to magnetic Pole pieces attached inside a trapezium like opening made to a depth in the outer circumference surface of the rotor disc, wherein the length of the depth being minutely more than the thickness of a magnetic Pole piece attached, herein the thickness means the length measured from a Pole surface to a Pole surface, the said opening been covered by a thin non magnetic metal plate with a thickness equivalent to the said minute length.

7. Spacecraft electric regenerator according to claim (01), in which the said power control and conversion process to sustain the power regenerative cycle is started by an external signal (39) to the Power control module (37) to turn ON the ON-OFF switch (36) to derive power from the storage device (35) to the starter mechanism (02) and to the geared electric high speed driver motor (11) to rotate to their respective predetermined velocities—Power cut OFF to the starter mechanism (02) when the rotor disc (01) attains its predetermined velocity measured by the RPM measuring circuit (40)—Speed control for the said driver motor (11)—driver disc (10) to synchronize with the rotor disc (01)—Time delay for the rotation to achieve stability from the power control module through the signals received from the RPM measuring circuit (40) and from the electric driver motor (11), the Voltage-Current generated in the armature coil assembly being converted and stored in the storage device and being reused by the power control module (37) with reference to FIG. (08).
